(19) United States
(12) Patent Application Publication
(10) Pub. No.: US 2004/0033009 A1
(43) Pub. Date: Feb. 19, 2004

(54) Optimal bistable switching in non-linear photonic crystals

(76) Inventors: Marin Soljacic, Somerville, MA (US); Steven G. Johnson, St. Charles, IL (US); Mihai Ibanescu, Piatra Neamt (RO); Yoel Fink, Cambridge, MA (US); John D. Joannopoulos, Belmont, MA (US); Shanhui Fan, Palo Alto, CA (US)

Correspondence Address: Samuels, Gauthier & Stevens LLP, 225 Franklin Street, Suite 3300, Boston, MA, 02110, US

(21) Appl. No.: 10/421,337

(22) Filed: Apr. 23, 2003

Related U.S. Application Data
(60) Provisional application No. 60/375,572, filed on Apr. 25, 2002.

(51) Int. Cl. G02B 6/26

(52) U.S. Cl. 385/16; 385/39

(57) ABSTRACT

An optical bi-stable switch includes a photonic crystal cavity structure using its photonic crystal properties to characterize a bi-stable switch so that optimal control is provided over input and output of the switch. A plurality of waveguide structures are included, at least one of the waveguide structures providing the input to the switch and at least one providing the output to the switch.

### PRIORITY INFORMATION

This application claims priority from provisional application Ser. No. 60/375,572 filed Apr. 25, 2002, which is incorporated herein by reference in its entirety.

### BACKGROUND OF THE INVENTION

The invention relates to the field of optical switching, and in particular to optimal bistable switching in non-linear photonic crystals.

The promising ability of photonic crystals to control light makes them ideal to miniaturize optical components and devices for eventual large-scale integration. Waveguides of cross-sectional area <λ², where λ is the carrier wavelength of signal in air, bends or radius of curvature <λ, wide angle splitters, cross connects, and channel-drop filters <λ in length have all already been demonstrated theoretically.

A very powerful concept that could be explored to implement all-optical transistors, switches, logical gates, and memory is the concept of optical bistability. In systems that display optical bistability, the outgoing intensity is a strongly non-linear function of the input intensity, and might even display a hysteresis loop. So far, bistability has been described in a few different 2D photonic crystal implementations. It has been shown that optical bistability can occur in a non-linear photonic crystal system that consists of 26 infinite rods with a defect in the center. A plane wave coming from air enters this structure; if its carrier frequency and intensity are in the appropriate regime, one can observe optical bistability. Optical bistability can be triggered by a plane wave impinging on a non-linear 2D photonic crystal when the carrier frequency is close to the band-edge, and the intensity is large enough, one observes optical bistability. Both of these systems involve intrinsic coupling to a continuum of accessible modes at every frequency, which limits controllability and peak transmission.

There is a need in the art to perform optical bistable switching in a non-linear photonic crystal system. Ideally, one would like to minimize operational power, losses, response&recovery time, and size, while providing optimal control over input&output, and maximize operational bandwidth.

### SUMMARY OF THE INVENTION

According to one aspect of the invention, there is provided an optical bi-stable switch. The optical bi-stable switch includes a photonic crystal cavity structure using its photonic crystal properties to characterize a bi-stable switch so that optimal control is provided over input and output of the switch. The switch includes a plurality of waveguide structures, at least one of the waveguide structures providing the input to the switch and at least one providing the output to the switch.

According to another aspect of the invention, there is provided a method of forming an optical bi-stable switch. The method includes providing a photonic crystal cavity structure using its photonic crystal properties to characterize a bi-stable switch so that optimal control is provided over input and output of the switch. Moreover, the method includes providing a plurality of waveguide structures, at least one of the waveguide structures providing the input to the switch and at least one providing the output to the switch.

### BRIEF DESCRIPTION OF THE DRAWINGS

FIG. 1 is schematic diagram of a square lattice 2D photonic crystal of high dielectric rods embedded in a low dielectric material showing the electric field to demonstrate optical bistability in accordance with the invention;

FIGS. 2A-2C are graphs demonstrating the transmission of Gaussian-envelope pulses through the photonic crystal of FIG. 1;

FIG. 3 are graphs demonstrating the transmission of CW pulses through the photonic crystal of FIG. 1;

FIG. 4 is a graph of the calculated P_{OUT}^{S} vs. P_{IN}^{S} for the photonic crystal of FIG. 1;

FIG. 5 is a schematic diagram of another embodiment of the photonic crystal of FIG. 1;

FIGS. 6A-6B are graphs of the calculated P_{OUT}^{S} vs. P_{IN}^{S} for the photonic crystal of FIG. 5; and

FIGS. 7A and 7B are schematic diagrams of a cross-connect in accordance with the invention.

### DETAILED DESCRIPTION OF THE INVENTION

Photonic crystals provide flexibility in designing a system that is effectively one-dimensional, although it is embedded in a higher-dimensional world. The invention uses photonic crystal waveguides that are one-dimensional and single mode, which provides optimal control over input and output. In particular, a 100% peak transmission can be achieved. The fact that the invention uses photonic crystals enables shrinking the system to be tiny in size (<λ³) and consume only a few mW of power, while having a recovery and response time smaller that 1ps. Because of these properties, the system is particular suitable for large-scale all-optical integration. Optically bistability is demonstrated by solving the Maxwell's equation numerically with minimal physical approximations. Furthermore, an analytical model is developed that describes the behavior of the system and is very useful in predicting optimal designs.

Ideally, one would work with 3D photonic crystal systems, or 2D photonic crystal slabs, or corrugated waveguides (1D photonic crystal slabs). For definiteness, 2D photonic crystal structures are used that can closely emulate the photonic state frequencies and field patterns of 2D photonic crystal slabs or 3D photonic crystals. In particular, cross sections of all localized modes in those systems are very similar to the profiles of the modes described hereinafter. Therefore, it simplifies the calculations without loss of generality to construct the invention in 2D photonic crystals, although the underlying analytical theory is not specific to the field patterns in any case. Qualitatively similar behavior will occur in 1D photonic crystal slabs (corrugated waveguides).

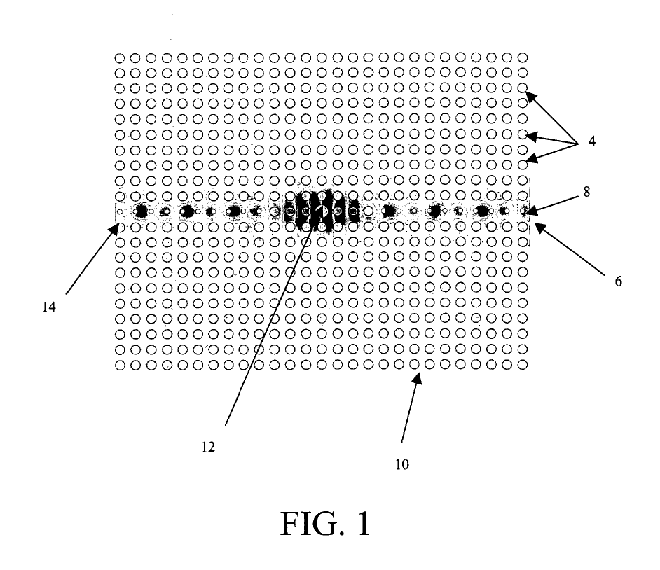

FIG. 1 is a schematic diagram of a square lattice 2D photonic crystal (PC) 10 of high dielectric rods 4 (ε_{H}=12.25) embedded in a low dielectric material (ε_{L}=2.25). The lattice spacing is denoted by a, and the radius of each rod is r=a/4. The invention focuses on the transverse-magnetic (TM) modes that have electric field parallel to the rods. To create single-mode waveguides 6, 14 inside of this PC 10, the radius of each rod 8 is reduced in line to r/3.

Moreover, a resonant cavity 12 supports a dipole-type localized resonant mode by increasing the radius of a single rod 14, surrounded by bulk crystal, to 5r/3. The resonant cavity is connected with the outside world by placing it 3 unperturbed rods away from the two waveguides 6, 14. One of the waveguides 6, 14 serves as the input port to the cavity 12 and the other serves as the output port. The cavity 12 couples to the two ports 6, 14 through tunneling processes.

It is important for optimal transmission that the cavity 12 be identically coupled to the input port and output ports. Moreover, it is important to consider a physical system where the high-index material has an instantaneous Kerr non-linearity so the index change is n_{H}cε₀n₂|E|², where n₂ is the Kerr coefficient. The Kerr effects are neglected in the low-index material. In order to simplify the computations without sacrificing the physics, only the region that is within the square of ±3 rods from the cavity is considered non-linear. Essentially all of the energy of the resonant mode is within this square, so this is the only region where the non-linearity will have a significant effect.

A numerical experiment is performed to explore the behavior of the inventive device. Namely, the full 2D non-linear finite-difference time domain (FDTD) equations are solved with perfectly matched layer (PML) boundary regions. The nature of these numerical experiments is that they model Maxwell's equations exactly, except for the discretization. Convergence is checked and the waveguide modes are matched inside the PC 10 to the PML region, the PC 10 and waveguides 6, 14 are terminated with distributed-Bragg reflectors, obtaining less than 4% amplitude reflection from the edge of the PC for the frequencies of interest.

The invention is designed so that it has a TM band gap of 18% between ω_{MIN}=0.24(2πc)/a and ω_{MAX}=0.29(2πc)/a. In addition, the single-mode waveguide can guide all of the frequencies in the TM band gap. Furthermore, the cavity is chosen so that it has resonant frequency of ω_{RES}=0.2581(2πc)/a and is strongly enough contained to have a Lorentizian transmission spectrum: t(ω)P_{OUT}(ω)/P_{IN}(ω)≈γ²/[γ²+(ω−ω_{RES})²], where P_{OUT} and P_{IN} are the outgoing and incoming powers respectively, and γ is the width of the resonance. The quality factor Q=ω_{RES}/2γ=557.

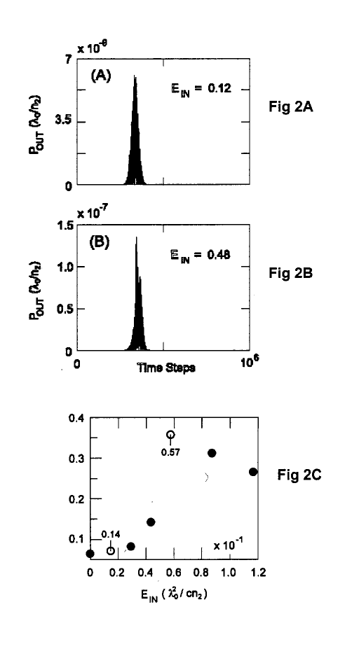

Off-resonance pulses are launched in the first numerical experiment whose envelope is Gaussian in time with full width at half-maximum (FWHM) Δω/ω₀32 1/1595, into the input waveguide, as shown in FIGS. 2A-2C. The carrier frequency of the pulses is ω₀=0.2573(2πc)/a so ω_{RES}−ω₀=3.8γ. When the peak power of the pulses is low, the response outputs are shown in FIG. 2A. Since it is not in the resonance peak, the output pulse energy

$$( {E}_{OUT} ≡ {\int }_{- ∞}^{∞} ⅆ {tP}_{OUT} )$$

is only a small fraction (6.5%) of the incoming pulse energy E_{IN}. As the incoming pulse energy is increased, the ratio E_{OUT}/E_{IN} increases, at first slowly. However, as the incoming pulse energy approaches the value of E_{IN}=(0.57*10⁻¹)*[(λ₀)²/cn₂], the ratio E_{OUT}/E_{IN} grows rapidly to 0.36, and the shape of the pulse at the output changes dramatically, as shown in FIG. 2B. After this point, E_{OUT}/E_{IN} slowly decreases as the incoming pulse energy increases. This behavior is shown in FIG. 2C, which is the graph demonstrating the E_{OUT}/E_{IN} vs. E_{IN} behavior.

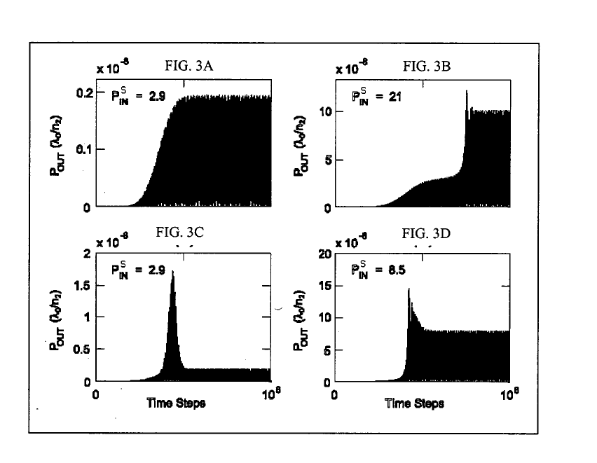

Moreover, the numerical experiment is repeated again, but this time continuous-wave (CW) signals are launched into the cavity instead of Gaussian pulses. There are two reasons for doing this. First, the upper branch of the expected hysteresis curve is difficult to probe using only a single input pulse. Second, it is much simpler to construct an analytical theory explaining the phenomena when CW signals are used. The amplitude of the input signals slowly grows from zero to a final CW steady state value. The time scale associated with this growth needs to be larger than the characteristic time scale associated with the resonant cavity; otherwise, one can observe “ringing” of the output signal. The steady state of P_{IN} and P_{OUT} are denoted by P_{IN}^{S} and P_{OUT}^{S}, respectively. To begin with, for low P_{IN} and P_{OUT}, P_{OUT}^{S}/P_{IN}^{S} slowly increases with increasing P_{IN}^{S}, and the shape of the output signal is a near-linear response resembling the shape of the input signal, as shown in FIG. 3A. However, at certain P_{IN}^{S}, P_{OUT}^{S}/P_{IN}^{S} jumps discontinuously, and the shape of the output pulse changes dramatically, as shown in FIG. 3B.

It is important to emphasize that for all CW signals that are launched, after some initial ringing, the output always converges to a steady state value, and there is only a single carrier frequency remaining, that of the input pulse. This suggest that the ringing observed in FIGS. 2B, 3B, and 3D are most likely not due to some non-linear instability, like self-phase modulation. Furthermore, since the cavity has only one mode, it is unlikely that this instability is related to the modulation instability phenomena observed with in-fiber bistable systems.

There is no observation of truncation of the bistable cycle, unlike what is seen in-fiber bistable systems. Consequently, the most likely explanation of the ringing that is observed is that it is due to the fact that, while the steady state is being reached, the pulse effectively observes a resonant state whose resonance frequency is changing in time. It is not surprising therefore that this non-linear time dynamics of reaching the steady state causes some “ringing” of the output pulse. This is an important problem that seems to be intrinsic to the class of systems described herein. Making the input pulse smoother does not alleviate the initial ringing since it is associated with the discontinuous jump of the system from one hysteresis branch to the other. It is expected the ringing to be smaller when one uses a time-integrating non-linearity or when one operates in the regime where there is no hysteresis loop. Alternatively, to get rid of the ringing, which could be detrimental for some applications, one could put linear band-pass filters at the output of the device.

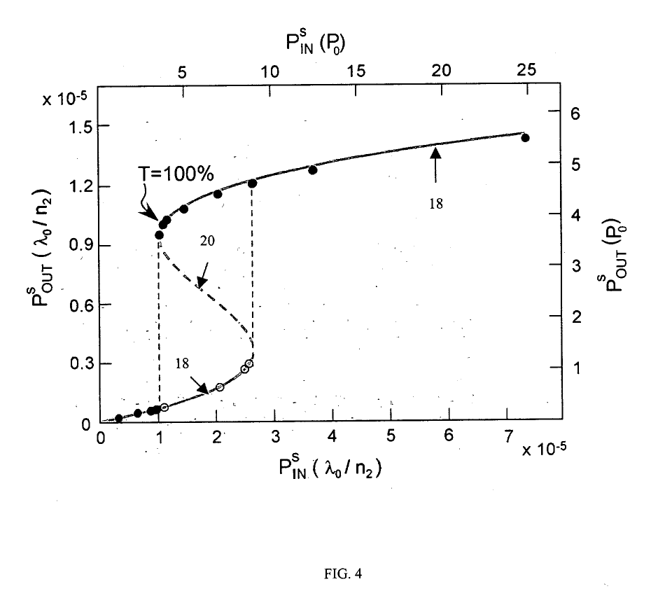

Hysteresis loops quite commonly occur in systems that exhibit optical bistability. The upper hysteresis branch is the physical manifestation of the fact that the system “remembers” that it had a high P_{OUT}/P_{IN} value previous to getting to the current value. There is an attempt to observe the upper hysteresis branch by launching pulses that are superpositions of CW signals and Gaussian pulses, where the peak of the Gaussian pulse is significantly higher than the CW steady state value. It is expected that the Gaussian pulse will “trigger” the device into a high P_{OUT}/P_{IN} state and, as the P_{IN} relaxes into its lower CW value, the P_{OUT} will eventually reach a steady state point on the upper hysteresis branch. This is confirmed by numerical experimentation after the CW value of P_{IN}^{S} passes the threshold of the upper hysteresis branch. The P_{OUT}^{S} value is always on the upper hysteresis branch, as shown in FIGS. 3C-3D. Furthermore, the observed P_{OUT}^{S} is plotted for a few values of P_{IN}^{S} as shown in FIG. 4 by the solid dots.

For the case of CW signals, one-can achieve a precise analytical understanding of the phenomena observed. In particular, it is demonstrated hereinafter that there is a single additional fundamental physical quantity associated with this cavity, in addition to Q and ω_{RES}, that allows one to fully predict the P_{OUT}^{S}(P_{IN}^{S}) behavior of the system. First, according to first-order perturbation theory, the field of the resonant mode will, through the Kerr effect, induce a change in the resonant frequency of the mode, given by:

$$\frac{\partial ω}{{ω}_{RES}} = - \frac{1}{4} * \frac{{\int }_{VOL} {ⅆ}^{d} r [ {\vert E ( r ) \cdot E ( r ) \vert}^{2} + 2 {\vert E ( r ) \cdot {E}^{*} ( r ) \vert}^{2} ] {n}^{2} ( r ) {n}_{2} ( r ) c {ϵ}_{0}}{{\int }_{VOL} {ⅆ}^{d} r {\vert E ( r ) \vert}^{2} {n}^{2} ( r )} \qquad ( 1 )$$

where n(r) is the unperturbed index of refraction, E(r,t)=[E(r)exp(iωt)+E*(r)exp(−iωt)]/2 is the electric field, n₂(r) is the local Kerr coefficient, cε₀n₂(r)n(r)|E(r)|²=δn(r) is the local non-linear index change, VOL of integration is over the extent of the mode, and d is the dimensionality of our system. A new dimensionless and scale-invariant parameter κ is introduced and is defined as:

$$κ ≡ {( \frac{c}{{ω}_{RES}} )}^{d} * \frac{{\int }_{VOL} {ⅆ}^{d} r [ {\vert E ( r ) \cdot E ( r ) \vert}^{2} + 2 {\vert E ( r ) \cdot {E}^{*} ( r ) \vert}^{2} ] {n}^{2} ( r ) {n}_{2} ( r )}{{{[ {\int }_{VOL} {ⅆ}^{d} r {\vert E ( r ) \vert}^{2} {n}^{2} ( r ) ]}^{2} {n}_{2} ( r ) \vert}_{MAX}} , \qquad ( 2 )$$

As will be discussed hereinafter, κ is a measure of the geometric non-linear feedback efficiency of the system. The parameter κ is called the non-linear feedback parameter, and is determined by the degree of spatial confinement of the field in the non-linear material. It is a very weak function of everything else. Moreover, the parameter κ is scale invariant because of the factor (c/ω_{RES})^{d}, and is independent of the material n₂ because of the factor n₂(r)|_{MAX}, which the maximum value of n₂(r) anywhere. Because the change in the field pattern of the mode due to the nonlinear effects or due to small deviations from the operating frequency is negligible, κ will also be independent of the peak amplitude. Since the spatial extent of the mode changes negligibly with a change in the Q of the cavity, κ is independent of Q. This is found to be true within 1% for a cavity with Q=557, 2190, and 10330, corresponding respectively to 3, 4, and 5 unperturbed rods comprising the walls. Indeed κ=0.095±0.003 is found across all the numerical experimental results in this work, regardless of input power, Q, and operating frequency.

For comparison, if one had a system in which all the energy of the mode were contained uniformly inside a volume (λ₀/2n_{H})³, κ would be approximately 0.34. Thus, κ is an independent design parameter. The larger the κ, the more efficient the system is. Moreover, κ facilitates system design since a single simulation is enough to determine it. One can then add rods to get the desired Q, and change the operating frequency ω₀, until one gets the desired properties.

An analytical model is constructed to predict the non-linear response of a cavity in terms of only three fundamental quantities: the resonance frequency ω_{RES}, the quality factor Q, and the nonlinear feedback parameter κ. From Equations (1) and (2), the relation δω=−(½)(ω_{RES}/c)^{d}κQcP_{OUT}^{S}n₂(r)|_{MAX} is obtained. Note that the integral in the denominator of those equations is proportional to the energy stored in the cavity, which is in turn proportional to QP_{OUT}^{S}. Next, a Lorentzian resonant transmission gives P_{OUT}^{S}/P_{IN}^{S}=γ²/[γ²+(ω₀−δω−ω_{RES})²]. This expression can be simplified by defining two useful quantities: δ=(ω_{RES}−ω₀)/γ, the relative detuning of the carrier frequency from the resonance frequency, and

$${P}_{0} ≡ \frac{1}{{κ {{Q}^{2} ( {ω}_{RES} / c )}^{d - 1} {n}_{2} ( r ) \vert}_{MAX}} ,$$

the “characteristic power” of the cavity. With these definitions the relation between P_{OUT}^{S} and P_{IN}^{S} becomes:

$$\frac{{P}_{OUT}^{S}}{{P}_{IN}^{S}} = \frac{1}{1 + {( \frac{{P}_{OUT}^{S}}{{P}_{0}} - δ )}^{2}} . \qquad ( 3 )$$

In general, this cubic equation can have either one or three real solutions for P_{OUT}^{S}, depending on the value of the detuning parameter δ. The bistable regime corresponds to three real solutions and requires a detuning parameter δ>\sqrt{3}. As discussed herein, the detuning used in accordance with the invention is ω_{RES}−ω₀=3.8γ, which means that δ=3.8, which is larger than the threshold needed for bistability. The simple form of Eq. (3) allows us to derive some general properties of the invented device. First of all, the P_{OUT}^{S}(P_{IN}^{S}) curve depends on only two parameters, P₀ and δ, each one of them having separate effects: a change in P₀ is equivalent to a rescaling of both P_{OUT}^{S} & P_{IN}^{S} axes by the same factor, while the shape of the curve can only be modified by changing δ.

From Eq. (3), one can also calculate some typical power levels for the device. For example, the input power needed for 100% transmission can be seen to be P_{100%}=δP₀. Another important input power level is that required to observe bistability by jumping from the lower branch of the hysteresis curve to the upper one, which corresponds to the rightmost point on the lower branch. The expression for this power level is complicated, but for δ not too close to \sqrt{3} this power can be approximated quite well by P_{b}=(4δ³/27)P₀ with less than 15% error for δ>4. Therefore, if low power operation of the device is wanted, the value of δ should not be much larger than the critical value of \sqrt{3}. The minimum power needed for bistability is attained when δ=\sqrt{3} in which case P_{b,min}=P_{100%}=\sqrt{3}P₀. The physical interpretation of P₀ is now apparent; P₀ sets the characteristic power needed to observe bistability in the cavity in question.

To check the analytic theory from described herein, κ=0.095 is obtained from a single non-linear run with a Gaussian plus a CW pulse. With the knowledge of Q and ω_{RES}, P_{OUT}^{S}(P_{IN}^{S}) can be obtained, which is shown in FIG. 4 by line 18. The analytic theory is seen to be in excellent agreement with the numerical experiments (dots and circles in FIG. 4); it predicts both the upper and the lower hysteresis branch exactly. The “middle” hysteresis branch, as shown in FIG. 4 by dashed line 20, is unstable although it represents a self-consistent solution to all the equations modeling the system, any tiny perturbation makes a solution on that branch decay either to the upper or to the lower branch.

While each non-linear numerical experiment requires extensive computational effort, with only a single numerical experiment all the parameters of the system can be measured. These parameters then allow us to accurately predict the behavior of the system for any ω₀−ω_{RES} and any P_{IN}^{S}. The small disagreement between the analytical theory and numerical experiments can, of course, be attributed to the fact that κ is constant only up to a few percent in our calculations. Furthermore, the adaptation of perturbation theory to leaky modes also introduces some error. Finally, the distributed-Bragg-reflector is not perfectly matched to the PC waveguide mode, so there is up to 4% amplitude reflection at the edge of the PC waveguide backwards to the cavity that is neglected in our analytical theory.

Since the profiles of the modes are so similar to the cross-sections of the 3D modes described herein, the 2D numerical experimental results can be used to estimate the power needed to operate a true 3D device, in a 3D photonic crystal, or 2D photonic crystal slab. Even a 1D corrugated waveguide will not behave very differently from this prediction. It is safe to assume that in a 3D device, the profile of the mode at different positions in the 3^{rd} dimension will be roughly the same as the profile of the mode in the 2D system. Moreover, the Kerr coefficient is assumed to be n₂=1.5*10⁻¹⁷m²/W, which is a value achievable in many nearly-instantaneous non-linear materials. Furthermore, assume that the carrier λ₀=1.55 μm. This implies that the characteristic power is P₀=154 mW, and the minimum power to observe bistability is P_{b,min}=266 mW.

This level of power is many orders of magnitude lower than that required by other small all-optical ultra-fast switches, and the reason for this is two-fold. First, the transverse area of the modes in the photonic crystal in question is only ≈(λ/5)²; consequently, to achieve the same-size non-linear effects, which depend on intensity, much less power is needed than in some other systems that have larger transverse modal area. Second, since there is a highly confined, high-Q cavity, the field inside the cavity is much larger than the field outside the cavity. This happens because of energy accumulation in the cavity. In fact, from the expression for the characteristic power P₀, one can see that the operating power falls as 1/Q². Building a high-Q cavity that is also highly confined is very difficult in systems other than photonic crystals, so one would expect high-Q cavities in photonic crystals to be nearly optimal systems with respect to the power required for optical bistability.

The peak non-linear index change for the results in FIG. 1 is δn/n=0.014. This value is physically too large to obtain using the Kerr effect in most instantaneous materials. However, the peak needed value of δn/n can be changed by changing Q and δ, as follows. First, it is evident that δn/n is proportional to δω/ω. From Eqs. (1-2), one can write δω/ω=−P_{OUT}^{S}/(2P₀Q). From Eq. (3) one can see that P_{OUT}^{S}/P₀ is roughly δ in the region of bistability. Combining these three results obtains δn/n˜δ/Q. Therefore, the required δn/n is decreased by increasing Q or decreasing δ. For Q=4100, which is still compatible with the bandwidth of 10 Gbit/sec signals, and δ=2.0, the peak δn/n is 0.001, which is much more easily achieved with conventional materials. Furthermore, the power needed to observe bistability is now as low as 5.2 mW.

Moreover, the inventive photonic crystal optically bistable device from FIG. 1 is coupled to its surroundings via two single-mode photonic crystal waveguides 6, 14. Without this feature, it would be very difficult to ever get high peak transmission. With it, in contrast, a 100% transmission is guaranteed for at least some input parameters. Consequently, the inventive device from FIG. 1 is suitable for use with other efficient photonic-crystal devices on the same chip. Furthermore, its small size, small operational power, and high speed makes this device particularly suitable for large-scale optics integration. Its highly non-linear dependence of output power on input power can be exploited for many different applications. For example, such a device can be used as a logical gate, a switch, to clean up optical noise, for power limiting, all-optical memory, amplification, or the like.

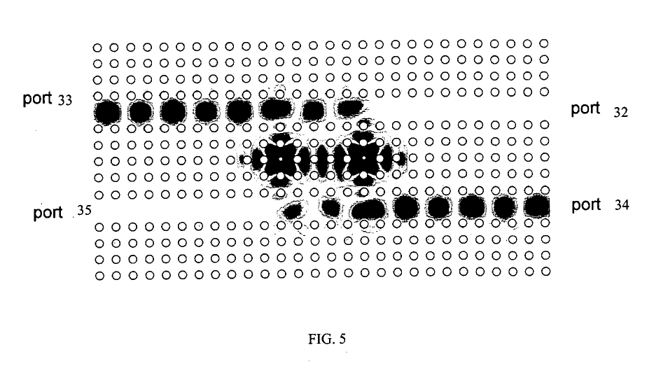

A second embodiment of the invention is provided to observe optical bistability in channel drop filters made from non-linear Kerr material, as shown in FIG. 5.

A photonic crystal 24 configured as a channel drop filter in accordance with the invention, as shown in FIG. 5, includes 4 equivalent ports 32-35. The port 33 is used as the input to the PC 24. If the carrier frequency is the same as the resonant frequency of the filter 24, 100% of the signal exits at output 34. If the carrier frequency is far away from the resonant frequency, most of the signal exits at output 32, while only a small amount exits at output 34. In fact, the transmission at output 34 has a Lorentzian shape, the same as the cavity shown in FIG. 1, where T₃₄ (ω)P_{OUT34}(ω)/P_{IN33}(ω)≈γ²/[γ²+(ω−ω_{RES})²], where P_{OUT34} and P_{IN33} are the outgoing and incoming powers respectively, and γ is the width of the resonance.

Again, similar to the system of FIG. 1, the PC 24 can also be characterized solely in terms of its resonant frequency ω_{RES}, and its quality factor Q. Any power that does not go into channel 34 exits through channel 32: T₂(ω)=1−T₄(ω); no power ever exists into channels 33 or 35. Because of this, one can think of the system of FIG. 1 and FIG. 5 as being entirely equivalent, except for one point. In the system of FIG. 1, power that does not exit at the output is reflected backwards into the channel where it came from. In contrast to the system of FIG. 5, all the power that does not get through to the channel 34 gets channeled into the channel 32, instead of being reflected back towards the input 33.

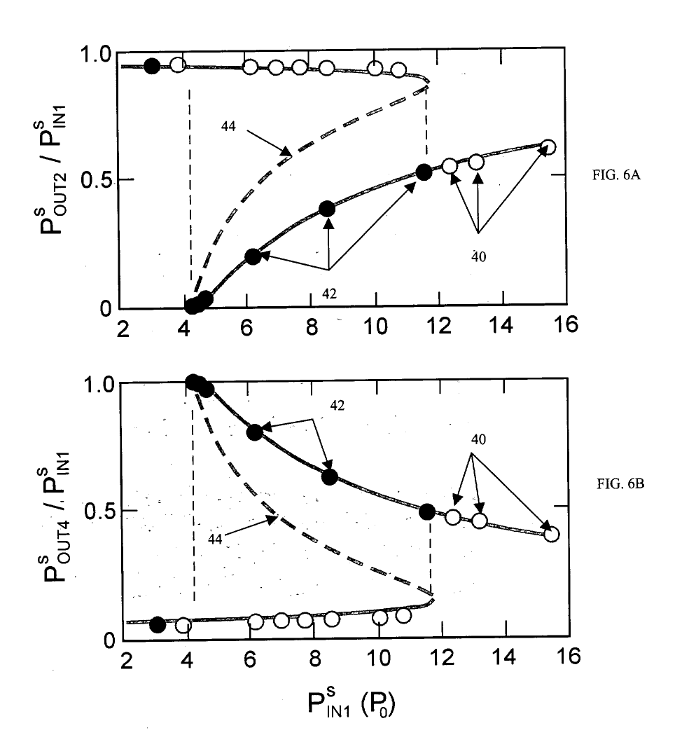

Non-linear analysis of the system of FIG. 5 closely follows the non-linear analysis of the system of FIG. 1. Numerical experiments are performed to observe bistability in a channel-drop filter. The results are shown in FIGS. 6A-6B; they behave exactly as expected, and closely mirror the behavior of the system from FIG. 1. In particular, the plots of FIGS. 6A-6B observe T≡P_{OUT}^{S}/P_{IN}^{S} vs. P_{IN}^{S} for the device 24 of FIG. 5. FIG. 6A shows the power observed at the output (34), while FIG. 6B shows the power observed at output 32. The input signal enters the device at port 33. The unfilled dots 40 are points obtained by launching CW signals into the device. The filled dots 42 are measurements that one can observe when launching superpositions of Gaussian pulses and CW signals into the cavity. The lines 44 are the analytical predictions, which clearly match the numerical experimental results.

Typically, the ports 33 and/or 35 will be used as the inputs to the system, and the ports 32 and/or 34 will be used as the outputs. Due to the design of this system, there are never any reflections back towards the inputs. Having zero reflections towards the inputs is a great advantage in integrated optics; reflections can be detrimental when integrating this device with other non-linear or active devices on the same chip. Furthermore, having 4 ports can offer much more design flexibility in building various useful devices, as will be discussed hereinafter.

Since reflections are of no concern, cascading devices of the type shown in FIG. 5 can be trivial. If one has two identical devices, (A), and (B), one discards the outputs 32 of both devices, and connects output 34 of device (A) into input 33 of device (B). The final operating input of the entire cascaded device is then input 33 of the device (A), while the operating output is the output 34 of the device (B). In a similar manner, one can proceed to cascade more than 2 devices. If a single channel-drop device has only a moderately non-linear I_{OUT}(I_{IN}) response, as is the case when the detuning δ is small, the I_{OUT}(I_{IN}) of the entire cascaded system closely resembles a step-function response, even for as few as 3-4 cascaded channel-drop devices. The ability to use bistability, in a regime where the non-linear effects are only moderate, drastically reduces the requirements on the operating power, Q, and the peak non-linearly induced δn that are needed to obtain a useful device.

A device with an I_{OUT}(I_{IN}) step-function response is perfect for all-optical clean-up of noise, provided that a valid signal is always above the threshold of the device, and the noise is always below. In that sense, the device can be used for all-optical reshaping/regeneration of signals, if it is placed immediately after an amplifier.

Once a channel-drop device has a step-function response, it can be used as an optical isolator between devices that do not have perfectly zero reflections. Suppose that the operating frequency in a waveguide is fixed. Furthermore, suppose that the useful forward propagating signals can be discriminated from the harmful backward propagating reflections. This is based on the fact that “useful” signals always have peak intensities above the device threshold, while the “harmful” reflections always have peak intensities below the threshold of the device. In that case, placing an I_{OUT}(I_{IN}) step-function response device inside of such a waveguide acts as an optical isolator. It allows “useful” signals to pass through, while getting rid of the “harmful” reflections. Note that the “harmful” reflections are not sent back where they came from. Instead, they are completely eliminated from the system, provided that one discards any power that ends up in channels 32 and 35 of the PC24. The optical isolator described here is many orders of magnitude smaller than any other optical isolator currently used. Furthermore, this is the first optical isolator amenable for all-optical integration at the moment.

The invention enables one to trivially implement an all-optical diode in settings where the peak signal amplitude, and the carrier frequency are both known. Imagine that the threshold of the PC 24 is tuned so that the threshold is just slightly below the signal level. Furthermore, a source of small linear loss is placed just after the PC 24. In that case, the signal will go through the channel-drop PC 24; afterwards it will suffer a small loss, and it will continue its propagation, albeit a bit attenuated, in the PC 24. However, consider a signal propagating in the opposite direction, it will first suffer the small loss, but then, due to the threshold behavior of the channel-drop, it will be discarded by the channel-drop out of the PC 24. In this way, the PC 24 has a very strong forward-backward asymmetry. The same signal can get through only if it is propagating forwards, but not if it is propagating backwards.

Perhaps an even more interesting class of applications is when one allows for two input signals into a channel drop PC 24 of FIG. 5. Suppose a strong pulse signal coming down input 33 with intensity just below the bistability threshold. In that case, the presence of another small signal coming down input 35 determines whether a large signal at output 34 or a small signal could be observed. In other words, if the device has a single input port 35, then what is observed at the output 34 is an amplified version of the input at port 35, provided that the pump applied at port 33 is constant.

The PC 24 thereby acts as an all-optical transistor. In fact, if the channels 33 and 35 are in phase and coherent, the symmetries of the device imply that the amplification observed at the output 34 is linear in the field, which enters at channel 35, rather than being linear in intensity, which enters at channel 35. This means that the incremental amplification of the intensity of channel 35 goes to infinity as the signal at channel 35 becomes infinitesimally small. On the other hand, if the inputs at channels 33 and 35 are mutually incoherent, the PC 24 can still serve as an all-optical transistor provided that our non-linearity is time-integrating. In this case, the amplification of the signal coming from channel 35 will be linear in intensity.

It is important to emphasize that almost any all-optical logical gate can be built using the non-linear channel-drop devices described herein. For illustration purposes, AND and NOT gates are described heretofore.

First, an AND gate is illustrated. It is assumed that the two logical inputs are mutually coherent. The inputs are combined to be coming down the same waveguide. This waveguide, carrying both logical signals in it, is then connected to the input 33 of the channel drop PC 24. The properties of the device are tuned so that a significant output comes down the channel 34 if and only if both logical signals are present at the same time. For example, only the added intensity of both signals being present at the same time is large enough to overcome the threshold of the channel drop device 24. Clearly, this way, the logical AND operation applied to the two logical signals in question is observed at port 34.

Once an AND gate is built, it is trivial to build a NOT gate. All that is required is to simply fix one of the logical inputs of the AND gate described in the herein, and instead of observing the output 34, the output 32 is observed. If the other logical input signal is zero, a logical one at the output 32 is observed. However, if the other logical input signal is logical one, zero at the output 32 will be observed since all the energy will be channeled to the output 34.

As mentioned before, optical bistability has numerous possible applications. The embodiment shown in FIG. 5 retains all the advantages of the embodiment from FIG. 1, in terms of being optimal with respect to size, power, and speed. In addition, the property of having zero reflections makes it optimal for integration with other devices on the same chip, while having two times more ports gives it even more flexibility in terms of designing useful all-optical devices.

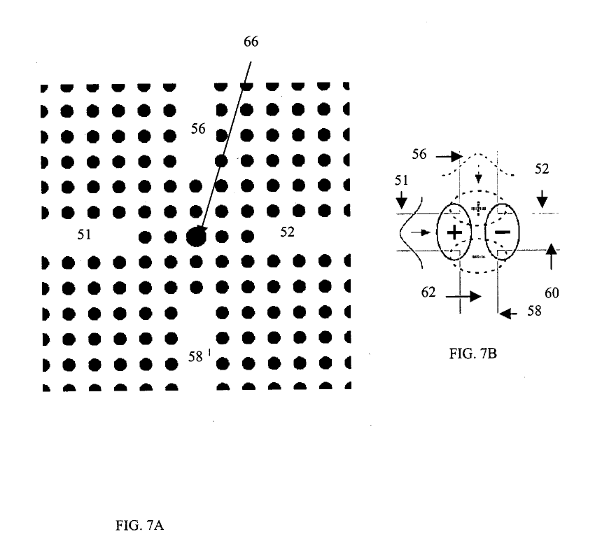

A third embodiment of the invention is presented having to do with observing bistability in non-linear photonic crystal cross-connects, as shown in FIGS. 7A-7B. FIG. 7A shows a system 50 that looks very similar to the one shown in FIG. 1, except there is another waveguide 62 which couples to the cavity, but comes from a direction perpendicular to the first , waveguide 60. The central large rod 66 supports two degenerate dipole modes. As shown in FIG. 7B, any signal coming from channel 51 couples only to the mode of the cavity that is odd with respect to the left-right symmetry plane. The reason for this is the fact that the channel 51 supports only a single mode, which is even with respect to the up-down symmetry plane. Consequently, it can couple only to the mode of the cavity that is even with respect to the up-down symmetry. However, once excited, that particular mode can decay only into channels 51 and 52 since it is odd with respect to left-right symmetry, while the guided modes in channels 56 and 58 are even with respect to that symmetry. As a consequence, any signal propagating in channels 51 and 52 never gets coupled into channels 56 and 58, and vice-versa. Using this technique, one can build great cross-connects in photonic crystals, which should be quite useful when building integrated optics circuits.

It is important to emphasize that one obtains quite a useful bistable device when one considers intensities of light sufficiently strong to trigger the underlying non-linearities of the system. In this scheme, the behavior of the system depends on the sum of the intensities of the two signals since the two modes excited by the two signals are mutually orthogonal. Consequently, the system displays the same behavior irrespective of the relative phase of the two signals. This is of crucial importance, since the phase of two different signals will be random in most applications of interest. If one has a signal propagating in channel 56 and 58, which is just below the threshold, then applying just a small control signal in channel 51 and 52 can kick the system above the threshold, and a strong transmission in channels 56-58 direction is observed. Consequently, the system 50 acts here as an optical transistor. The reason this scheme works is the fact that even the non-linear system 50, when both dipole modes are being excited, preserves the symmetries of the system 50 needed to eliminate the cross-talk.

The non-linear cross-connect system can also be used for most applications proposed for optical bistability, while being optimal in terms of power, size, integrability, and speed. Nevertheless, another interesting application of this particular system occurs when the system of FIG. 7A is modified a bit. The left-right symmetry is maintained and also the up-down symmetry, but not the 4-fold symmetry, so that, for example, rotating the system by 90 degrees will not leave it unchanged. One way of achieving this would be to elongate the central large rod 56 in the up-down direction to make it elliptical. The signal that propagates in channels 56 and 58 will never be coupled into channels 51 and 52. However, these two signals do not have the same carrier frequencies anymore. Such a system will have some interesting applications, even in the linear regime.

Consider what happens with a non-linear system. A signal is applied in channel 46 at frequency ω_{AB}, which is just below the bistability threshold. This signal is to be called the pump. Now apply a small signal in the channel 51, with frequency ω₁₂, and intensity just large enough to kick the system above the bistability threshold; where the small signal is to be the control. Clearly, this is a way of using a small intensity signal in one frequency to control the behavior of a large intensity signal in another frequency. Such a system 50 should be perfect for optical imprinting, which is the conversion of a signal of one frequency into another frequency. An added benefit of this system 50 compared to other optical-imprinting systems is the fact that the two signals are automatically separated at the output. One does not have to add additional de-multiplexing devices to the output in order to separate the two frequencies.

However, it is important to emphasize that the instantaneous Kerr non-linearity can actually cause energy transfer from field ω₁₂ into field ω_{AB}; e.g. even if initially there is no energy in field ω₁₂, it can be created through transfer from field ω_{AB}. This effect could be beneficial for some applications also, but it is expected that there will be large parameter regimes where it can be neglected.

Although the present invention has been shown and described with respect to several preferred embodiments thereof, various changes, omissions and additions to the form and detail thereof, may be made therein, without departing from the spirit and scope of the invention.

What is claimed is:

1. An optical bi-stable switch comprising:
a photonic crystal cavity structure using its photonic crystal properties to characterize a bi-stable switch so that optimal control is provided over input and output of said switch; and
a plurality of waveguide structures, at least one of said waveguide structures providing said input to said switch and at least one providing said output to said switch.

2. The optical bi-stable switch of claim 1, wherein said photonic crystal cavity structure comprises a plurality of rods.

3. The optical bi-stable switch of claim 1, wherein one of said rods provides a resonant mode.

4. The optical bi-stable switch of claim 1, wherein said waveguides structures comprises two waveguides.

5. The optical bi-stable switch of claim 1, wherein said waveguide structures are designed to prevent backward reflections.

6. The optical bi-stable switch of claim 1, wherein said waveguide structures are aligned perpendicular to each other.

7. The optical bi-stable switch of claim 1, wherein said photonic crystal properties comprise the resonant frequency, ω_{RES}, the quality factor Q, and the non-linear feedback strength κ of said photonic crystal cavity.

8. The optical bi-stable switch of claim 1, wherein said photonic crystal cavity structure comprises 2D photonic crystal slabs.

9. The optical bi-stable switch of claim 1, wherein said photonic crystal cavity structure comprises a 1D photonic crystal corrugated high-index contrast waveguide.

10. The optical bi-stable switch of claim 1, wherein said photonic crystal cavity structure comprises a 3D photonic crystal.

11. A method of forming an optical bi-stable switch comprising:
providing a photonic crystal cavity structure using its photonic crystal properties to characterize a bi-stable switch so that optimal control is provided over input and output of said switch; and
providing a plurality of waveguide structures, at least one of said waveguide structures providing said input to said switch and at least one providing said output to said switch.

12. The method of claim 11, wherein said photonic crystal cavity structure comprises a plurality of rods.

13. The method of claim 11, wherein one of said rods provides a localized resonant mode.

14. The method of claim 11, wherein said waveguides structures comprise two waveguides.

15. The method of claim 11, wherein said waveguide structures are designed to prevent backward reflections.

16. The method of claim 11, wherein said waveguide structures are aligned perpendicular to each other.

17. The method of claim 11, wherein said photonic crystal properties comprise the resonant frequency, ω_{RES}, the quality factor Q, and the non-linear feedback strength κ of said photonic crystal cavity.

18. The method of claim 11, wherein said photonic crystal cavity structure comprises 2D photonic crystal slabs.

19. The method of claim 11, wherein said photonic crystal cavity structure comprises a 1D photonic crystal corrugated high-index contrast waveguide.

20. The method of claim 11, wherein said photonic crystal cavity structure comprises a 3D photonic crystal.
